(19) United States
(12) Patent Application Publication
(10) Pub. No.: US 2007/0009715 A1
(43) Pub. Date: Jan. 11, 2007

(54) Water vapour barrier paper

(76) Inventors: Jean-Michel Santarella, Vienne (FR); Noel Cartier, Vienne (FR); Pierre Mary, Labouquerie (FR); Francois Mathevet, Jardin (FR)

Correspondence Address: NIXON & VANDERHYE, PC, 901 NORTH GLEBE ROAD, 11TH FLOOR, ARLINGTON, VA, 22203, US

(21) Appl. No.: 10/575,722

(22) PCT Filed: Oct. 13, 2004
(86) PCT No.: PCT/FI04/00609

§ 371 Date: Jun. 21, 2006

(30) Foreign Application Priority Data
Oct. 14, 2003 (FR) 0350682

(51) Int. Cl. G03G 7/00

(52) U.S. Cl. 428/195.1

(57) ABSTRACT

Cold sealable paper consisting of an actual support paper (1) comprising on the face side thereof at least one printing layer (2) and on the reverse side thereof a sealable layer (3), characterized in that it further has, on at least one of the two sides, face or reverse, a water vapour barrier layer (4) comprising a mixture of acrylic polymers as an emulsion, the total acid number of which is between 30 and 65, the mixture comprising at least 5% by weight of wax.

The invention relates to novel barrier papers having a low permeability to water vapour, these papers being able to be cold sealed, heat sealed or they can be twistable papers for confectionery. In practice, these products are more particularly intended for the flexible packaging field, e.g. confectionary, chocolate bar, coffee, biscuit and washing powder packages.

The papers used for these applications must have a certain number of properties, such as especially a low permeability to water vapour, to grease and, when necessary, to oxygen and aroma.

The so called “sealable” paper is often used in connection with all these applications. The sealability of the paper is obtained by applying, on the whole or on one part of one of the sides of the actual support paper, a layer of a specific composition consisting generally of (natural or synthetic) latex. Depending on the nature of the latex used, the paper can be cold sealable or heat sealable (thermo sealable).

The confectionery papers can be in the form of so-called “twistable” papers, i.e. these papers can be twisted. This is the case e.g. with candy papers. The twistable paper is a paper having a sufficient deformation and resistance capacity for absorbing the torsion energy during the packaging without being torn. This capacity comes, among other high mechanical characteristics, from a cross directional elongation in the order of 8%.

WO 94/26513 describes a recyclable paper, the characteristics of which do not allow using it as a twistable or sealable paper. In fact, the paper described in this document allows this in relation with food packaging, especially with beverage packages, the main objective being that it is recyclable and has a water vapour barrier. To do this, the support is coated with a first layer comprising a polymer such as e.g. an ethylene/vinyl acetate copolymer, then a second layer consisting of an emulsion combining an acrylic styrene copolymer and wax, in a proportion respectively of between 20 and 90% and from 5 to 70% by dry weight.

WO 96/05054 describes a recyclable paper of the same type as the one previously described, except for the fact that the second layer consists advantageously of a styrene-butadiene copolymer used in maximum proportions of 90% by dry weight of the layer.

DE-A-4445193 describes a paper comprising a support coated with a composite three-layered gas barrier. The three-layered composite is formed of a metal layer situated in a sandwich structure between two layers of film-forming polymers, the polymer being heat sealable. The coating must thus take place in three separate steps, the first film-forming polymer, the metal layer and the second film-forming polymer respectively.

The applicant has noticed that the use of a mixture of acrylic polymers as an emulsion, having a total acid number of between 30 and 65, and a wax concentration less than 5%, reduced strongly the permeability to water vapour. Such a product corresponds e.g. to a product sold by the MICHELMAN company under the name “MR130”.

This product can be used for manufacturing cold or hot sealable papers, but also twistable papers for confectionery.

Consequently and according to a first characteristic, the invention concerns a cold sealable barrier paper consisting of an actual support paper printed on the face side thereof, and having a sealable layer on the whole or on one part of the reverse side thereof. This paper is characterized in that it further has, on the reverse side thereof, a water vapour barrier layer comprising a mixture of acrylic polymers as an emulsion, the total acid number of which is between 30 and 65, the mixture comprising less than 5% of wax by weight.

In the rest of the description and in the claims, the expressions are defined as follows:
“total acid number” denotes the milligrams of potassium hydroxide needed for neutralizing the acidity of one gram of polymer in normalized conditions,
“actual support paper” denotes a coated calendered (cellulose+pigment layer composed of mineral pigments and of a latex-type binder) or uncoated calendered (consisting of only cellulose) support paper, the mass of which is between 25 and 110 g/m²; advantageously between 25 and 60 g/m².

Likewise, the printing corresponds to one or more ink layers, the layers being deposited by any technique, such as heliogravure or flexogravure printing, known by a person skilled in the art.

Moreover, the expression “cold sealable layer” denotes a layer prepared from natural or synthetic latex; these formulations are denoted by the term “cold seal” by those skilled in the art, the layer being applied in an amount of 2-5 g/m².

The wax present in the acrylic polymer mixture is notably paraffin.

As already mentioned, the water vapour barrier layer consists of a mixture of acrylic polymers as an emulsion, the total acid number of which is between 30 and 65, the mixture representing advantageously 100% by dry weight of the layer. Advantageously, the mixture of polymers contains from 2 to 10% by weight of resin and less than 5% of wax by weight. Preferably, the mixture of acrylic polymers is a mixture of styrene-acrylic polymers.

The cold sealable paper of the invention can appear in several forms.

In a first embodiment, the water vapour layer is positioned directly on the printing, which itself is directly in contact with the actual paper.

In practice, this layer can be applied at one go, respectively in an amount of 2-10 mg/m² as humid matter or of 1-5 mg/m² as dry matter, by any technique known by a person skilled in the art, such as especially but in a non limitative manner, heliogravure or reverse roll.

The sealable layer is, in turn, applied directly on the whole or on one part of the reverse side of the actual paper, in an amount of for example 1-5 mg/m² as dry matter, especially by the helio coating technique.

Moreover, the applicant has noticed that, completely surprisingly, the polymer constitutive of the water vapour barrier layer had anti-adherent properties, whereby the presence of a supplemental anti-adherent layer on the water vapour barrier layer becomes unnecessary.

In order to confer oxygen and aroma barrier properties on this embodiment, at least one oxygen and aroma barrier layer is inserted between the actual support paper and the sealable layer.

In practice, the oxygen barrier layer comprises an ethylene/vinyl alcohol (EVOH) copolymer or a polyvinyl alcohol (PVA) polymer deposited in an amount of 3-4 mg/m² as dry matter.

In an advantageous embodiment, the oxygen barrier layer consists exclusively of an ethylene/vinyl alcohol (EVOH) copolymer or polyvinyl alcohol (PVA), even though other embodiments can be envisaged as a mixture with other polymers or as a mixture with mineral fillers, the ethylene copolymer/EVOH or polyvinyl alcohol (PVA) representing, in a continuous manner, at least 50% by weight of the layer.

Moreover, the applicant has noticed the product sold by MICHELMAN based on an acrylic polymer emulsion under the reference “MR 130” did not only have water vapour barrier and anti-adherent properties, but was also heat sealable at a temperature of between 120 and 250° C.

Consequently, this means that the previously described cold sealable layer can be replaced with one and only layer, which acts as a water vapour barrier layer and is also thermo sealable.

In other words, the invention relates also to a heat sealable barrier paper, i.e. at a temperature of between 120 and 250° C., consisting of an actual support paper, printed or printable on the face side thereof. The support is characterized in that it has at least on its reverse side a heat sealable layer and a water vapour barrier layer comprising a mixture of acrylic polymers as an emulsion, the total acid number of which is between 30 and 60, the mixture comprising less than 5% by weight of wax. Preferably, the mixture comprises from 2 to 10% of resin and represents 100% by dry weight of the layer.

In the same way as previously, the mixture of acrylic polymers is advantageously a mixture of styrene acrylic polymers, like the wax is paraffin.

It is also possible to provide an advanced heat sealable paper, i.e. a paper further having oxygen and aroma barrier properties. In this case, between the actual paper and the water vapour barrier layer, an oxygen and aroma barrier layer is inserted, which is of the same type as previously described in case of the cold sealable paper.

In order to protect the oxygen barrier layer and to enhance the water vapour layer without affecting the sealability, the paper has additionally a second water vapour barrier layer deposited directly on the printing.

Finally, the specific water vapour barrier layer of the invention can also be applied to confectionery papers, i.e. for twistable papers.

In this case, the paper for confectionery intended to be twistable consists of an actual twistable support paper, the face of which is printed or printable. This paper is characterized in that a water vapour barrier layer, comprising a mixture of acrylic polymers as an emulsion, the total acid number of which is between 30 and 65, the mixture having less than 5% of wax by weight, is deposited on the printing.

In an advanced embodiment, the twistable paper has oxygen and aroma barrier properties. In this case, between the water vapour barrier and the printing there is inserted an oxygen and aroma barrier layer of the previously described type, i.e. a layer comprising an ethylene/vinyl alcohol (EVOH) copolymer or polyvinyl alcohol (PVA) polymer, the mass of which is between 3 and 4 g/m².

In the same way as previously, in an advantageous embodiment, the mixture of acrylic polymers as an emulsion contained in the water vapour barrier layer further contains from 2 to 10% of resin and represents 100% by dry weight of the layer. In a preferred embodiment, the mixture of acrylic polymers is a mixture of styrene acrylic polymers. Accordingly, the wax is notably paraffin.

In an advantageous embodiment, the face side of the support paper is provided with a paraffin layer, the mass of which is between 2 and 6 g/m².

The invention and the advantages which stem therefrom will become more apparent from the following illustrative examples supported by the appended figures.

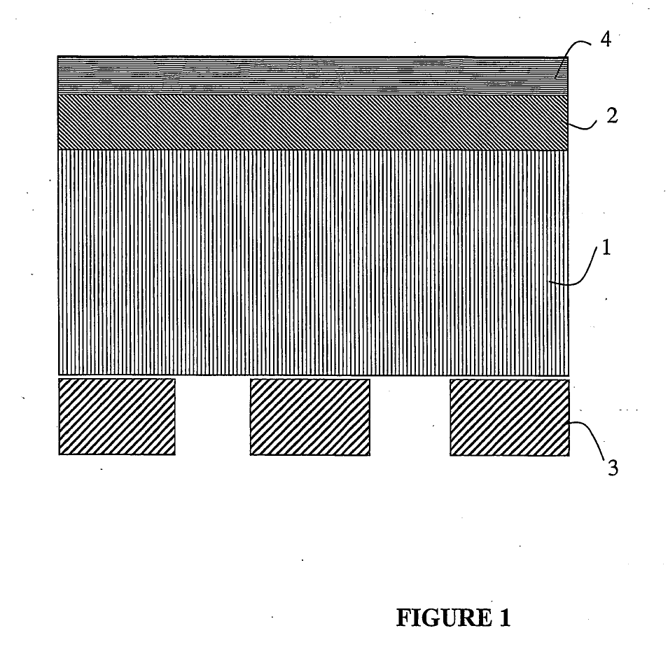

FIG. 1 illustrates a first embodiment of a cold sealable water vapour barrier paper according to the invention.

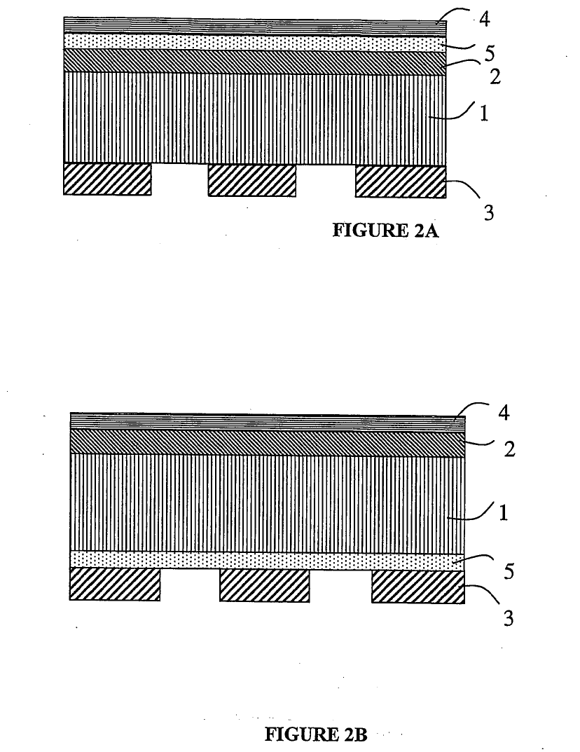

FIG. 2 (2A, 2B) illustrates an advanced embodiment of the FIG. 1, in which the presence of at least one oxygen and aroma barrier layer is provided.

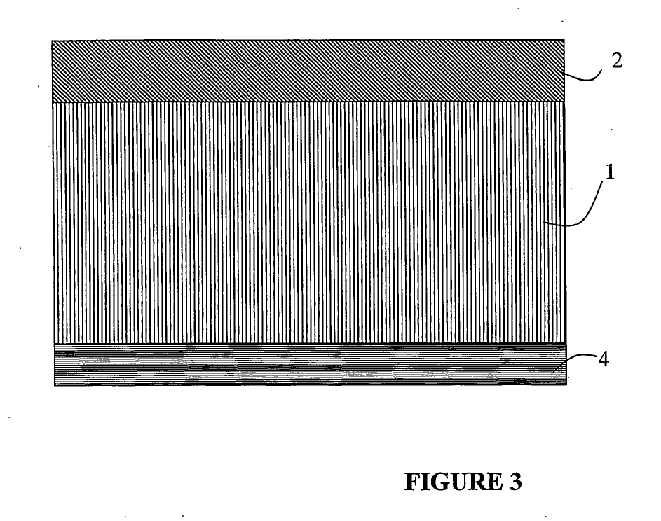

FIG. 3 illustrates a heat sealable water vapour barrier paper according to the invention.

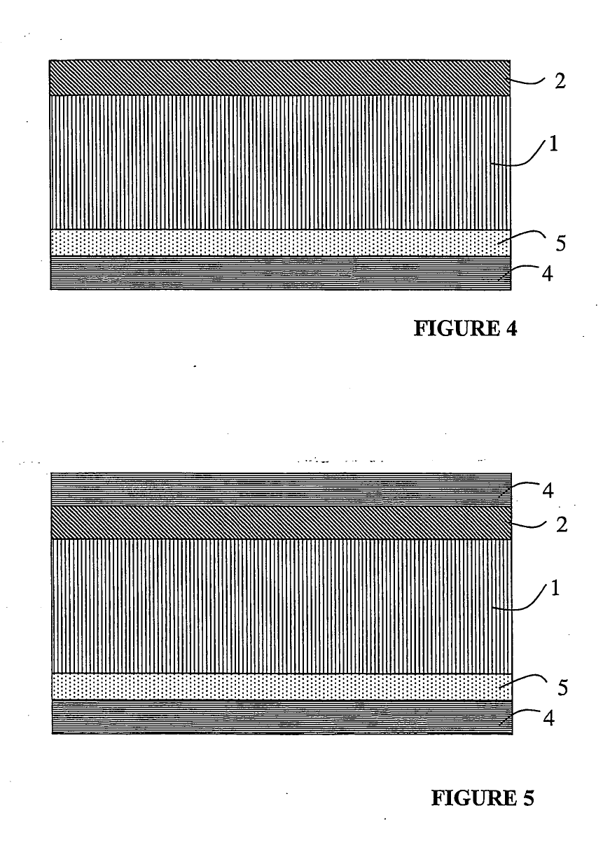

FIG. 4 illustrates an advanced embodiment of the FIG. 3, in which at least one oxygen and aroma barrier layer is provided.

FIG. 5 illustrates an advanced embodiment of the FIG. 4, in which a second water vapour barrier layer is provided.

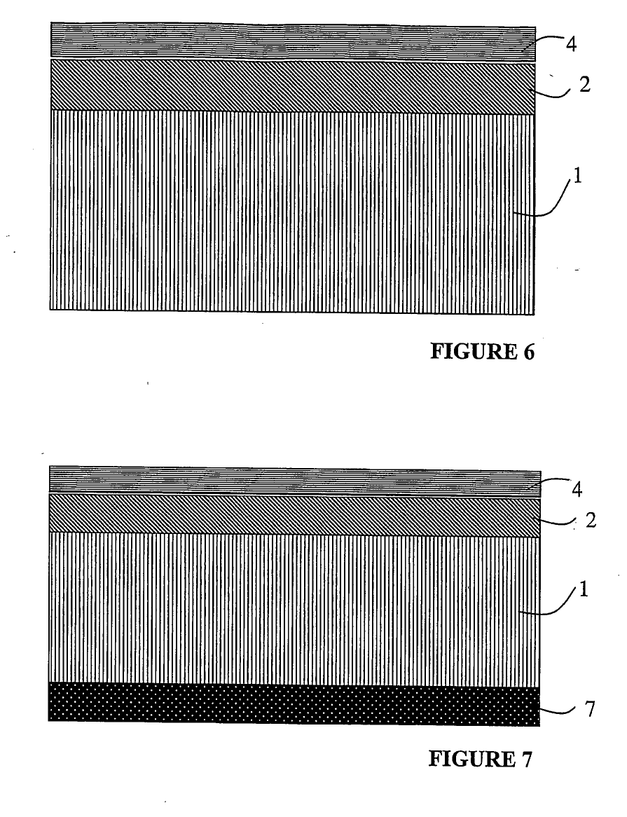

FIG. 6 illustrates a water vapour barrier paper for confectionery according to the invention.

FIG. 7 illustrates a second embodiment of a water vapour barrier paper for confectionery according to the invention.

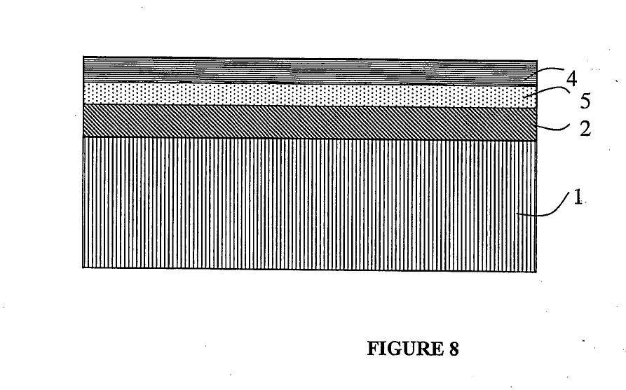

FIG. 8 illustrates advanced embodiments of the FIG. 6, in which at least one oxygen and aroma barrier is provided.

The different examples hereinafter describe the assembly of structures of cold, heat sealable papers or of twistable papers covered by the invention.

The water vapour barrier, oxygen barrier and printing layers as well as the cold sealable layer, which are mentioned in these examples, have always the same composition from one example to another, respectively:
a water vapour barrier layer designated by the reference (4): 100% by dry weight of MR 130, sold by MICHELMAN, mass 6 g/m²,
an oxygen and aroma barrier layer designated by the reference (5): 100% ethylene/vinyl alcohol copolymer by dry weight, sold under the name EXCEVAL by KURARAY, mass 3.5 g/m²,
a printing layer designated by the reference (2): i.e. a printing layer e.g. of seven colours, deposited on the paper by heliogravure (water-based or solvent-based inks),
cold sealable layer designated by the reference (3): 100% by dry weight of latex, sold under the name IP 7883 by the company SUN chemicals, mass deposited in an amount of 2-5 g/m².

### EXAMPLE 1

### Cold Sealable Paper

The product represented in this first example corresponds to the structure illustrated in FIG. 1.

The cold sealable paper consists of the following elements:
a support paper (1) sold by the Applicant under the name ROCAL 400 BAR, the mass of which is 37 g/m²,
a printing (2) of 7 colours, deposited directly at the surface of the support (1),
the cold sealable layer (3), applied directly on the reverse side of the support paper (1),
the water vapour barrier layer (4).

### EXAMPLE 2

### Cold Sealable Paper

Example 2 corresponds to an advanced embodiment of the example 1, insofar that it further has oxygen and aroma barrier properties.

The structure of the cold sealable paper of the example 2 corresponds to the structure illustrated in the FIGS. 2A, 2B.

The FIG. 2A corresponds to the FIG. 1, with the exception that it has an oxygen and aroma barrier layer (5) between the water vapour barrier layer (4) and the printing (2).

In another advanced embodiment represented in the FIG. 2B, the oxygen and aroma barrier layer (5) is not positioned in direct contact with the printing (2) but between the reverse side of the actual paper (1) and the cold sealable layer (3).

### EXAMPLE 3

### Heat Sealable Paper

Example 3 concerns a heat sealable paper, the structure of which is represented in the FIG. 3.

This paper consists of the actual paper (1) corresponding to that described in the previous examples, covered with a printing (2) on the face side, and on reverse with a water vapour barrier layer (4) deposited in an amount of 5-8 g/m² as dry matter.

### EXAMPLE 4

### Heat Sealable Paper

Example 4 is an advanced embodiment of the example 3 insofar as the structure consists of at least one oxygen and aroma barrier layer.

This layer (5) is positioned between the actual paper and the water vapour barrier layer (FIG. 4).

### EXAMPLE 5

### Heat Sealable Paper

Example 5 is an advanced embodiment of the example 4 insofar as the structure consists of a second water vapour barrier layer (4) situated directly on the printing, thus on the face side.

### EXAMPLE 6

### Twistable Paper

Example 6 corresponds to a twistable paper for confectionery, the structure of which is represented in the FIG. 6. This paper comprises an actual paper (1) sold by AHLSTROM under the name ROCAL 400 MO, having a weight of 40 g/m². This support is printed (2), the printing being itself covered with a water vapour barrier layer (4).

### EXAMPLE 7

### Twistable Paper

Example 7 corresponds to an advanced embodiment of the example 4 and is represented in the FIG. 7.

In this illustrative example, the reverse side of the support paper is coated with paraffin (7), the mass of which is 3 g/m².

### EXAMPLE 8

### Twistable Paper

Example 8 corresponds to an advanced embodiment of the example 6 insofar as the structure further contains at least one oxygen and aroma barrier layer 5, this layer being positioned e.g. between the water vapour barrier layer and the printing layer (FIG. 8).

### EXAMPLE 9

An example of the water vapour barrier for the structure, object of the example 3.

PVE=20 g/m²/day, 38° C., 90% relative humidity.

1. Cold sealable barrier paper consisting of an actual support paper (1) printed on the face side thereof and having a sealable layer (3) on the whole or on one part of the reverse side thereof, characterized in that it further consists, on the face side thereof, of a water vapour barrier layer (4) consisting of a mixture of acrylic polymers, and less than 5% of wax by weight, which has been applied as an emulsion, the total acid number of the acrylic polymers being between 30 and 65.

2. Cold sealable barrier paper consisting of an actual support paper (1) printed on the face side thereof and having a sealable layer (3) on the whole or on one part of the reverse side thereof, characterized in that it further consists, on the face side thereof, of a water vapour barrier layer (4) consisting of a mixture of acrylic polymers and less than 5% of wax by weight, which has been applied as an emulsion, the total acid number of the acrylic polymers being between 30 and 65, and of at least one oxygen aroma barrier layer (5) between the printing (2) and the water vapor barrier layer (4), or between the actual support paper and the sealable layer, the oxygen aroma barrier layer (5) consisting of ethylene/vinyl alcohol (EVOH) copolymer or polyvinyl alcohol (PVA) polymer, the mass of which is between 3 and 4 g/m².

3. Cold sealable barrier paper consisting of an actual support paper (1) printed on the face side thereof and having a sealable layer (3) on the whole or on one part of the reverse side thereof, characterized in that it further consists, on the face side thereof, of a water vapour barrier layer (4) consisting of a mixture of acrylic polymers, and less than 5% of wax by weight, which has been applied as an emulsion, the total acid number of the acrylic polymers being between 30 and 65, and the mixture comprising less than 5% of wax by weight, and of at least one oxygen aroma barrier layer (5) between the printing (2) and the water vapor barrier layer (4), or between the support paper (1) and the sealable layer (3), the oxygen aroma barrier layer (5) consisting of ethylene/vinyl alcohol (EVOH) copolymer or polyvinyl alcohol (PVA) polymer as a mixture with other polymers or as a mixture with mineral fillers, the EVOH or PVA representing at least 50% by weight of the layer.

4. Cold sealable barrier paper according to claim 1 characterized in that the water vapour barrier layer is positioned directly in contact with the printing and has a mass of between 2 and 10 g/m² as humid matter.

5. Cold sealable barrier paper according to claim 1, characterized in that the sealable layer is positioned directly in contact with the whole or one part of the reverse side of the actual paper.

6. Cold sealable barrier paper according to claim 1, characterized in that the mixture of acrylic polymers as an emulsion is a mixture of styrene acrylic polymers.

7. Cold sealable barrier paper according to claim 1, characterized in that the mixture of acrylic polymers further contains from 2 to 10% by weight of resin.

8. Cold sealable barrier paper according to claim 1, characterized in that the mixture of acrylic polymers represents 100% by dry weight of the layer.

9. Cold sealable barrier paper according to claim 2, characterized in that the ethylene/vinyl alcohol (EVOH) copolymer or the polyvinyl alcohol (PVA) represents 100% by dry weight of the layer.

10. Heat sealable barrier paper consisting of an actual support paper (1) printed or printable on the face side thereof, characterized in that it consists, at least on its reverse side, of a heat sealable layer and water vapour barrier layer (4), said water vapour barrier layer (4) consisting of a mixture of acrylic polymers, and less than 5% of wax by weight, which has been applied as an emulsion, the total acid number of the acrylic polymers being between 30 and 55.

11. Heat sealable barrier paper consisting of an actual support paper (1) printed or printable on the face side thereof, characterized in that it consists, at least on its reverse side, of a heat sealable layer and water vapour barrier layer (4), the water vapour barrier layer (4) consisting of a mixture of acrylic polymers, and less than 5% of wax by weight, which has been applied as an emulsion, the total acid number of the acrylic polymers being between 30 and 55, and of an oxygen aroma barrier layer (5) between the actual paper (1) and the water vapour barrier layer (4), the oxygen aroma barrier layer (5) consisting of ethylene/vinyl alcohol (EVOH) copolymer and polyvinyl alcohol (PVA) polymer, the mass of which is between 3 and 4 g/m².

12. Heat sealable barrier paper consisting of an actual support paper (1) printed or printable on the face side thereof, characterized in that it consists, at least on its reverse side, of a heat sealable layer and water vapour barrier layer (4), the water vapour barrier layer (4) consisting of a mixture of acrylic polymers, and less than 5% of wax by weight, which has been applied as an emulsion, the total acid number of the acrylic polymers being between 30 and 65, and of an oxygen aroma barrier layer (5) between the actual paper (1) and the water vapour barrier layer (4), the oxygen aroma barrier layer (5) consisting of ethylene/vinyl alcohol (EVOH) copolymer and polyvinyl alcohol (PVA) polymer as a mixture with other polymers or as a mixture with mineral fillers, the EVOH or PVA representing at least 50% by weight of the layer.

13. Heat sealable barrier paper according to claim 10, characterized in that said heat sealable layer and water vapour barrier layer is a unitary layer having both heat sealable and water vapour barrier properties.

14. Heat sealable barrier paper according to claim 10 characterized in that it further contains a second water vapour barrier layer deposited directly on the printing.

15. Heat sealable barrier paper according to claim 10, characterized in that the mixture of acrylic polymers as an emulsion is a mixture of styrene acrylic polymers.

16. Heat sealable barrier paper according to claim 10 characterized in that the mixture of acrylic polymers further contains from 2 to 10% by weight of resin.

17. Heat sealable barrier paper according to claim 10, characterized in that the mixture of acrylic polymers represents 100% by dry weight of the layer.

18. Heat sealable barrier paper according to claim 11, characterized in that the ethylene/vinyl alcohol (EVOH) copolymer or polyvinyl alcohol (PVA) represents 100% by dry weight of the layer.

19. Confectionery barrier paper consisting of an actual twistable support paper (1) printed on the face side thereof, characterized in that it further consists, directly in contact with the printing (2), of a water vapour barrier layer (4) consisting of a mixture of acrylic polymers, and less than 5% of wax by weight, which has been applied as an emulsion, the total acid number of the acrylic polymers being between 30 and 65.

20. Confectionery barrier paper consisting of an actual twistable support paper (1) printed on the face side thereof, characterized in that it further consists of a water vapour barrier layer (4) consisting of a mixture of acrylic polymers, and less than 5% of wax by weight, which has been applied as an emulsion, the total acid number of the acrylic polymers being between 30 and 65, and of at least one oxygen and aroma barrier layer (5) consisting of an ethylene/vinyl alcohol (EVOH) copolymer or a polyvinyl alcohol (PVA) polymer, the mass of which is between 3 and 4 g/m², positioned between the water vapour barrier layer (4) and the printing (2).

21. Confectionery barrier paper consisting of an actual twistable support paper (1) printed on the face side thereof, characterized in that it further consists of a water vapour barrier layer (4) consisting of a mixture of acrylic polymers, and less than 5% of wax by weight, which has been applied as an emulsion, the total acid number of the acrylic polymers being between 30 and 65, and of at least one oxygen and aroma barrier layer (5) consisting of an ethylene/vinyl alcohol (EVOH) copolymer or a polyvinyl alcohol (PVA) polymer as a mixture with other polymers or as a mixture with mineral fillers, the EVOH or PVA representing at least 50% by weight of the layer, the mass of which is between 3 and 4 g/m², positioned between the water vapour barrier layer (4) and the printing (2).

22. Confectionery barrier paper consisting of an actual twistable support paper printed on the face side thereof, characterized in that it further consists, directly in contact with the printing (2), of a water vapour barrier layer (4) consisting of a mixture of acrylic polymers, and less than 5% of wax by weight, which has been applied as an emulsion, the total acid number of the acrylic polymers being between 30 and 65 and of a paraffin layer (7) having a mass of 2-6 g/m² on the reverse side of the support paper (1).

23. Confectionery barrier paper consisting of an actual twistable support paper printed on the face side thereof, characterized in that it further consists of a water vapour barrier layer (4) consisting of a mixture of acrylic polymers, and less than 5% of wax by weight, which has been applied as an emulsion, the total acid number of the acrylic polymers being between 30 and 65, of at feast one oxygen and aroma barrier layer (5) consisting of an ethylene/vinyl alcohol (EVOH) copolymer or a polyvinyl alcohol (PVA) polymer, the mass of which is between 3 and 4 g/m², positioned between the water vapour barrier layer (4) and the printing (2), and of a paraffin layer (7) having a mass of 2-6 g/m² on the reverse side of the support paper (1).

24. Confectionery barrier paper consisting of an actual twistable support paper (1) printed on the face side thereof, characterized in that it further consists of a water vapour barrier layer (4) consisting of a mixture of acrylic polymers, and less than 5% of wax by weight, which has been applied as an emulsion, the total acid number of the acrylic polymers being between 30 and 65, of at least one oxygen and aroma barrier layer (5) consisting of an ethylene/vinyl alcohol (EVOH) copolymer or a polyvinyl alcohol (PVA) polymer as a mixture with other polymers or as a mixture with mineral fillers, the EVOH or PVA representing at least 50% by weight of the layer, the mass of which is between 3 and 4 g/m², positioned between the water vapour barrier layer (4) and the printing (2), and of a paraffin layer (7) having a mass of 2-6 g/m² on the reverse side of the support paper (1).

25. Confectionery paper according to claim 19, characterized in that the mixture of acrylic polymers as an emulsion is a mixture of styrene acrylic polymers.

26. Confectionery paper according to claim 19, characterized in that the mixture of acrylic polymers further contains from 2 to 10% by weight of resin.

27. Confectionery paper according to claim 19, characterized in that the mixture of acrylic polymers represents 100% by dry weight of the layer.

28. Confectionery paper according to claim 10, characterized in that the ethylene/vinyl alcohol (EVOH) copolymer or polyvinyl alcohol (PVA) represents 100% by dry weight of the layer.
